(19) United States
(12) Patent Application Publication
(10) Pub. No.: US 2024/0214799 A1
(43) Pub. Date: Jun. 27, 2024

(54) LAYER 2 SECURITY ENHANCEMENT

(71) Applicant: Apple Inc., Cupertino, CA (US)

(72) Inventors: Fangli Xu, Beijing (CN); Bobby Jose, San Diego, CA (US); Dawei Zhang, Saratoga, CA (US); Haijing Hu, Los Gatos, CA (US); Murtaza A. Shikari, Mountain View, CA (US); Naveen Kumar R. Palle Venkata, San Diego, CA (US); Pavan Nuggehalli, San Carlos, CA (US); Ralf Rossbach, Munich (DE); Sarma V. Vangala, Campbell, CA (US); Shu Guo, Beijing (CN); Weidong Yang, San Diego, CA (US)

(73) Assignee: Apple Inc., Cupertino, CA (US)

(21) Appl. No.: 17/910,339

(22) PCT Filed: Sep. 24, 2021
(86) PCT No.: PCT/CN2021/120409

§ 371 Date: Mar. 30, 2023

(51) Int. Cl. H04W 12/037; H04W 12/108

(52) U.S. Cl. CPC H04W 12/037; H04W 12/108

(57) ABSTRACT

Provided is a method of a transmitter in a wireless communication system, that includes: generating protocol data units (PDU) in layer 2 (L2); performing security protection on a control PDU of the PDUs in L2 to obtain a protected control PDU for the control PDU, wherein the control PDU in a sublayer lower than service data adaptation protocol (SDAP); and transmitting the protected control PDU.

### CROSS REFERENCE TO RELATED APPLICATION

This application is a 371 U.S. National Phase of PCT International Patent Application No. PCT/CN2021/120409, filed Sep. 24, 2021, which is herein incorporated by reference in its entirety for all purposes.

### TECHNICAL FIELD

This application relates generally to wireless communication systems, and more specifically to security enhancement in Layer 2 (L2).

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE): fifth-generation (5G) 3GPP new radio (NR) standard: the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, new radio (NR) node or g Node B (gNB), which communicate with a wireless communication device, also known as user equipment (UE).

### SUMMARY

According to an aspect of the present disclosure, a method of a transmitter in a wireless communication system is provided that comprises generating protocol data units (PDU) in layer 2 (L2): performing security protection on a control PDU of the PDUs in L2 to obtain a protected control PDU for the control PDU, wherein the control PDU in a sublayer lower than service data adaptation protocol (SDAP); and transmitting the protected control PDU.

According to an aspect of the present disclosure, a method of a receiver in a wireless communication system is provided that comprises receiving a protected control PDU in layer 2 (L2), wherein the protected control PDU is obtained by performing security protection on a control PDU in a sublayer lower than service data adaptation protocol (SDAP).

According to an aspect of the present disclosure, a method of a transmitter in a wireless communication system is provided that comprises generating protocol data units (PDU) in layer 2 (L2): performing security protection on a header of a PDU of the PDUs in L2 to obtain a protected PDU for the PDU, wherein the PDU in a sublayer lower than packet data convergence protocol (PDCP); and transmitting the protected PDU.

According to an aspect of the present disclosure, a method of a receiver in a wireless communication system is provided that comprises receiving a protected PDU in layer 2 (L2), wherein the protected PDU is obtained by performing security protection on at least a header of a PDU in a sublayer lower than packet data convergence protocol (PDCP).

According to an aspect of the present disclosure, an apparatus for a transmitter is provided that comprises: one or more processors configured to perform steps of the above-mentioned method of the transmitter.

According to an aspect of the present disclosure, an apparatus for a receiver that comprises: one or more processors configured to perform steps of the above-mentioned method of the receiver.

According to an aspect of the present disclosure, it is provided a computer readable medium having computer programs stored thereon which, when executed by one or more processors, cause an apparatus to perform steps of the above-mentioned method.

According to an aspect of the present disclosure, it is provided a computer program product comprising computer programs which, when executed by one or more processors, cause an apparatus to perform steps of the above-mentioned method.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a user equipment (UE) in accordance with some embodiments.

FIG. 2 illustrates a flowchart for an exemplary method of a transmitter in accordance with some embodiments.

FIG. 3 illustrates a flowchart for an exemplary method of a receiver in accordance with some embodiments.

FIG. 4 illustrates a flowchart for an exemplary method of a transmitter in accordance with some embodiments.

FIG. 5 illustrates a flowchart for an exemplary method of a receiver in accordance with some embodiments.

FIG. 6 illustrates a communication exchange in connection with security protection in accordance with some embodiments of the present disclosure.

FIG. 7 illustrates an exemplary block diagram of an apparatus of a transmitter in accordance with some embodiments.

FIG. 8 illustrates an exemplary block diagram of an apparatus of a receiver in accordance with some embodiments.

FIG. 9 illustrates example components of a device in accordance with some embodiments.

FIG. 10 illustrates example interfaces of baseband circuitry in accordance with some embodiments.

FIG. 11 illustrates components in accordance with some embodiments.

FIG. 12 illustrates an architecture of a wireless network in accordance with some embodiments.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

Carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

In order to increase the bandwidth and thus increasing the bitrate, a user equipment (UE) may be connected to more than one serving cell. In New Radio (NR), one serving cell may be designated as a primary cell (PCell), while some other cells may be secondary cells (SCells). In some cases, a PCell and SCells for UE may correspond to (supported by) a same base station. In some other cases, PCell and SCells may correspond to (supported by) different base stations.

In wireless communications, every frequency band has a primary component carrier which is called a primary cell (PCell) and others are called secondary cell (SCell). Whenever necessary, the SCell can be activated for data transmission.

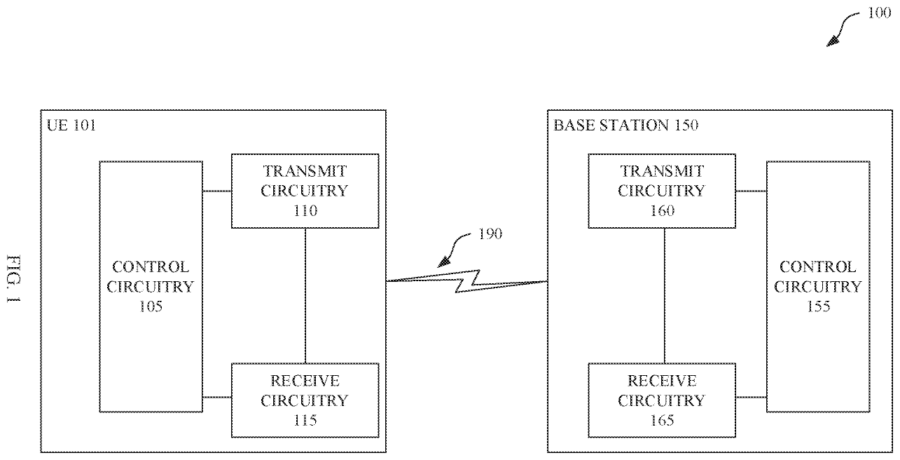

FIG. 1 illustrates a wireless network 100, in accordance with some embodiments. The wireless network 100 includes a UE 101 and a base station 150 connected via an air interface 190.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120-degree area with an array of antennas directed to each sector to provide 360-degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with MTC. In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuitry 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g., messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person to person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is comprised of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is comprised of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

The UE and various base stations (for example, base stations that support all kinds of serving cells including PCell and SCell, or base stations that act as the network device of PCell or SCell for communicating with the UE) described in the following embodiments may be implemented by the UE 101 and the base station 150 described in FIG. 1.

In current access stratum (AS) security framework, on unicast transmission is allowed after AS security is activated. The UE may compute a signature (e.g., MAC-I) and transmit the signature in RRCResumeRequest and RRCReestablishmentRequest to help a network (NW) device in the wireless communication system to identify the UE. In particular, L2 security configuration may be applied for transmission security and stability.

Layer 2 may comprise sublayers including a medium access control (MAC) layer, a radio link control (RLC) layer, a packet data convergence protocol (PDCP) layer, and a service data adaptation protocol (SDAP) layer.

In current AS security configuration, AS security may include integrity protection and ciphering of radio resource control (RRC) signaling (e.g., signaling radio bearers (SRB)) and user data (e.g., data radio bearers (DRBs)). The AS security mode command (SMC) procedure is for RRC and user plane (UP) security algorithms negotiation and RRC security activation. The current AS security configuration is per DRB, and all the DRBs belonging to a same protocol data unit (PDU) session use a same security configuration. The integrity protection algorithm and ciphering algorithm are common for SRB1, SRB2, SRB3 (if configured) and DRBs configured with integrity protection, with a same keyToUse value.

According to current L2 security configuration, for PDCP layer, the data unit that is ciphered is the MAC-I and the data part of the PDCP Data PDU except the SDAP header and the SDAP control PDU if included in the PDCP service data unit (SDU). The ciphering is not applicable to PDCU control PDUs. Furthermore, the data unit that is integrity protected is the PDU header and the data part of the PDU before ciphering. The integrity protection is applied to PDCP data PDUs of SRBs and the PDCP Data PDUs of DRBs. In other words, PDCH headers and SDAP headers can be protected by current integrity protection mechanism, and data parts and MAC-i in PDCP layer can be protected by ciphering.

In summary, current L2 security protection is applied on SDAP control PDU (protected by integrity protection in the PDCP layer), SDAP header (protected by integrity protection in the PDCP layer), PDCP header (protected by integrity protection in the PDCP layer) and PDCP data PDUs (protected by ciphering in PDCP layer). However, the control PDUs in sublayers lower than the SDAP layer, i.e., the PDCP layer, the RLC layer and the MAC layer are not protected. Also, the headers in sublayers lower than the PDCP layer are not protected. Since the control PDU may affect the RACH procedure, MIMO configuration, activation configuration, or scheduling information, unprotected control PDUs and headers may lead to fake control PDUs in L2 layer and fake L2 headers during the wireless communication. In particular, fake control PDUs in L2 layer may lead to wrong UE operations and may break a connection between the UE and the NW. Fake L2 headers may lead to unnecessary packet discarding in a receiver.

Table 1 illustrates the control PDU or header of PDU which is not protected under current security protection mechanism, and may be security protected in accordance with the embodiments of the present disclosure.

TABLE 1

| L2 | Channel/category | Messages or headers to be protected |
|---|---|---|
| | Header | SDAP header |
| | | PDCP header |
| | | RLC header |
| | | MAC sub-header |
| | | Backhaul Adaptation Protocol (BAP) header |
| | Control | SDAP |
| | | End-marker Control PDU |
| | | PDCP |
| | | PDCP status report |
| | | Robust Header Compression (ROHC) feedback |
| | | Ethernet Header Compression (EHC) feedback |
| | | RLC |
| | | STATUS PDU |
| | | BAP |
| | | Flow control feedback |
| | | Flow control polling |
| | | Backhaul Radio Link Failure (BH RLF) indication |
| | UL MAC CE | Uplink Scheduling |
| | | Buffer Status Report (BSR) |
| | | Power headroom reports (PHR) |
| | | Random Access |
| | | Cell Radio Network Temporary Identity (C-RNTI) |
| | | Common Control Channel (CCCH) |
| | | Multiple Input Multiple Output (MIMO) |
| | | Bit Error Ratio (BER) |
| | | Codec rate/MMTEL related |
| | | Recommended bit rate query |
| | | Integrated Access and Backhaul (IAB) |
| | | Number of desired guard symbols |
| | DL MAC CE | Channel-State Information (CSI)/Channel-State Information |
| | | (SRS) related |
| | | Semi-persistent (SP) Zero Power (ZP) CSI Reference Signal |
| | | (CSI-RS) Resource Set Activation/Deactivation |
| | | SP SRS Activation/Deactivation |
| | | SP CSI reporting on Physical Uplink Control Channel |
| | | (PUCCH) activation/Deactivation |
| | | Aperiodic (AP) CSI Trigger State Subselection |
| | | SP CSI-RS/CSI Interference Measurement (CSI-IM) |
| | | Resource Set Activation/Deactivation |
| | | SRS Pathloss Reference RS Update |
| | | MIMO related |
| | | Transmission Configuration Indicator (TCI) state Indication |
| | | for UE-specific Transmission Configuration Indicator |
| | | (PDCCH) |
| | | TCI States Activation/Deactivation for UE specific Physical |
| | | Downlink Shared Channel (PDSCH) |
| | | PUCCH spatial relation Activation/Deactivation |
| | | Enhanced TCI states Activation/Deactivation for UE-specific |
| | | PDSCH |
| | | Enhanced PUCCH Spatial Relation Activation/Deactivation |
| | | Enhanced SP/AP SRS Spatial Relation Indication |
| | | Serving Cell Set based SRS Spatial Relation Indication |
| | | Carrier Aggregation (CA) SCell activation/deactivation |
| | | SCell Activation/Deactivation |
| | | Industrial Internet of Things (IIOT) duplication |
| | | Duplication Activation/Deactivation |
| | | Duplication RLC Activation/Deactivation |
| | | Random access related |
| | | UE Contention Resolution Identity |
| | | Random Access Response |
| | | Discontinuous Reception (DRX) related |
| | | DRX Command |
| | | Long DRX Command |
| | | Uplink Timing |
| | | Timing Advance Command |
| | | IAB related |
| | | Absolute Timing Advance Command |
| | | Timing Delta |
| | | Codec rate/MMTEL related |
| | | Recommended bit rate |

Thus, in order to provide enhancement for L2 security mechanism, the present disclosure provide a method and apparatus of a transmitter and a method and apparatus of a receiver to provide improved protection in L2.

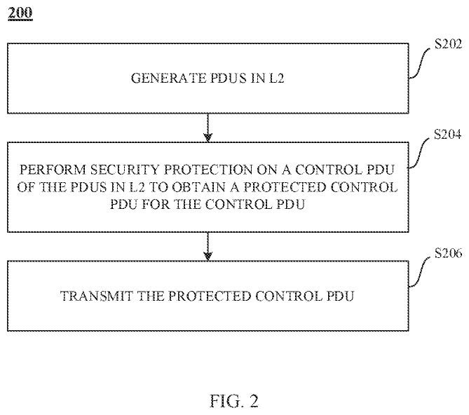

FIG. 2 illustrates a flowchart for an exemplary method of a transmitter in accordance with some embodiments. The method 200 illustrated in FIG. 2 may be implemented by the UE 101 or base station 150 described in FIG. 1 as a transmitter in the wireless communication system.

At step S202, the transmitter may generate PDUs in L2. The PDUs in L2 may include SDAP PDU, PDCP PDU, RLC PDU, MAC PDU, or MAC sub PDU.

At step S204, the transmitter of the wireless communication system may perform security protection on a control PDU of the PDUs in L2 to obtain a protected control PDU for the control PDU, wherein the control PDU in a sublayer lower than service data adaptation protocol (SDAP). For example, the control PDU to be protected may be a PDCP control PDU, a RLC control PDU or a MAC control subPDU (MAC control element (MAC-CE)).

The security protection for the control PDU may include at least one of integrity protection, ciphering protection or HASH protection based on corresponding security protection algorithm.

In some embodiment, in the integrity protection mechanism, the protected control PDU may be determined by applying an integrity protection algorithm on the control PDU to be protected. Based on an output of the integrity protection algorithm, a signature (e.g., MAC-I) may be determined, and a combination of the control PDU and the signature may be determined as the protected control PDU. For example, the signature may be assembled with original control PDU to obtain the protected control PDU.

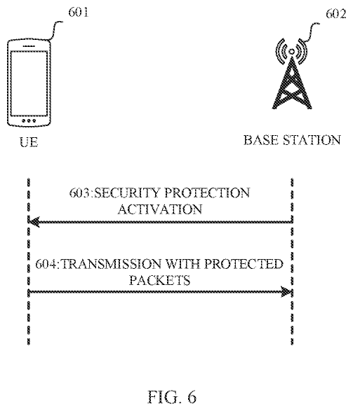

For example, a field of MAC-I may be added to a status PDU as illustrated in FIG. 6.2.2.5-1 in TS 38.322, the status PDU may be security protected by computing and adding a MAC-I to generate a protected status PDU. Other RLC control PDUs, PDCP control PDUs as illustrated in TS 38.322 or MAC control PDUs as illustrated in TS 38.321 may also be integrity protected in a similar way.

In some implementations, the integrity protection algorithm may include integrity protection algorithms for 5G system, e.g., 128-NIA1, 128-NIA2, or 128-NIA3. In some other implementations, the integrity protection algorithm may include integrity protection algorithms for LTE system or 3G system, e.g., EIA1, EIA2, EIA3, UIA1, or UIA2. Those skilled in the art may apply any other possible integrity protection algorithm on the control PDU according to actual situation. By reusing the existing integrity protection algorithm, the improved security protection may be implemented with minimum cost.

Inputs of the integrity protection algorithm for the control PDUs may include: a COUNT parameter: a DIRECTION parameter: a BEARER parameter; and an integrity protection key.

The COUNT parameter and the BEARER parameter may be set based on any possible values to differentiate different control PDUs, or being common to all the control PDUs to be protected.

In some examples, the COUNT parameter of the integrity protection algorithm may be a fixed COUNT value. For example, the COUNT parameter of the integrity protection algorithm may be set to 0 or any other possible values. In some other examples, the COUNT parameter of the integrity protection algorithm may be a sequency number (SN) allocated in a lower layer. For example, for a PDCP control PDU to be protected, the COUNT parameter of the integrity protection algorithm may be determined by a RLC SN. For a RLC control PDU to be protected, the COUNT parameter of the integrity protection algorithm may be determined by a MAC SN. In yet other examples, the COUNT parameter of the integrity protection algorithm may be determined as a random value. In case that the COUNT parameter of the integrity protection algorithm is a random value, the random value may be indicated to a peer entity. The random value may be indicated either in an explicit manner or an implicit manner. For the implicit manner, the random value may be indicated by an index corresponding to the random value.

In some examples, the BEARER parameter of the integrity protection algorithm may be a BEARER ID of a bearer associated with the control PDU. In another example, the BEARER parameter of the integrity protection algorithm may be a fixed value. For example, the BEARER parameter of the integrity protection algorithm may be set to 0 or any other possible values. In some other examples, the BEARER parameter of the integrity protection algorithm may be a control PDU type indication. For example, the BEARER parameter of the integrity protection algorithm may be a value in a field of the control PDU which indicates a type of the control PDU to be protected. In yet some other examples, the BEARER parameter of the integrity protection algorithm may be a value in any other specified field of the control PDU to be protected. For example, the type of the control PDU may be represented by an LCID of a MAC-CE.

The DIRECTION parameter of the integrity protection algorithm may indicate an uplink (UL) direction or a downlink (DL) direction. In some examples, the DIRECTION parameter of the integrity protection algorithm may be set to 0 to indicate the UL direction and 1 to indicate the DL direction. Those skilled in the art may set the DIRECTION parameter of the integrity protection algorithm to any other possible values according to actual situation.

The integrity protection key may include an integrity protection key K_{RRCint} or K_{UPint} (as identified in TS 38.300). K_{RRCint} may be a key derived by the base station for integrity protection of RRC signaling. K_{UPint} may be a key derived by the base station for integrity protection of UP traffic. Also, those skilled in the art may derive the integrity protection key in any other possible ways according to actual situation.

In some other implementations, in the ciphering mechanism, the protected control PDU may be determined by applying a ciphering algorithm on the control PDU to be protected. An output of the ciphering algorithm may be determined as the protected control PDU.

In some implementations, the ciphering algorithm may include ciphering algorithms for 5G system, e.g., 128-NEA1, 128-NEA2, or 128-NEA3. In some other implementations, the ciphering algorithm may include ciphering algorithms for LTE system or 3G system, e.g., 128-EEA1, 128-EEA2, 128-EEA3, UEA1, or UEA2. Those skilled in the art may apply any other possible ciphering algorithm on the control PDU according to actual situation.

Inputs of the ciphering algorithm may include: a COUNT parameter: a DIRECTION parameter; a BEARER parameter; and an encryption key.

The COUNT parameter and the BEARER parameter may be set based on any possible values to differentiate different control PDUs, or being common to all the control PDUs to be protected.

In some examples, the COUNT parameter of the ciphering algorithm may be a fixed COUNT value. For example, the COUNT parameter of the ciphering algorithm may be set to 0 or any other possible values. In some other examples, the COUNT parameter of the ciphering algorithm may be a sequency number (SN) allocated in a lower layer. For example, for a PDCP control PDU to be protected, the COUNT parameter of the ciphering algorithm may be determined by a RLC SN. For a RLC control PDU to be protected, the COUNT parameter of the ciphering algorithm may be determined by a MAC SN. In yet other examples, the COUNT parameter of the ciphering algorithm may be determined as a random value. In case that the COUNT parameter of the ciphering algorithm is a random value, the random value may be indicated to a peer entity. The random value may be indicated either in an explicit manner or an implicit manner. For the implicit manner, the random value may be indicated by an index corresponding to the random value.

In some examples, the BEARER parameter of the ciphering algorithm may be a BEARER ID of a bearer associated with the control PDU. In another example, the BEARER parameter of the ciphering algorithm may be a fixed value. For example, the BEARER parameter of the ciphering algorithm may be set to 0 or any other possible values. In some other examples, the BEARER parameter of the ciphering algorithm may be a control PDU type indication. For example, the BEARER parameter of the ciphering algorithm may be a value in a field of the control PDU which indicates a type of the control PDU to be protected. In yet some other examples, the BEARER parameter of the ciphering algorithm may be a value in any other specified field of the control PDU to be protected. For example, the type of the control PDU may be represented by an LCID of a MAC-CE.

The DIRECTION parameter of the ciphering algorithm may indicate an uplink (UL) direction or a downlink (DL) direction. In some examples, the DIRECTION parameter of the ciphering algorithm may be set to 0 to indicate the UL direction and 1 to indicate the DL direction. Those skilled in the art may set the DIRECTION parameter of the ciphering algorithm to any other possible values according to actual situation.

The encryption key may include an encryption key K_{RRCenc} or K_{UPenc} (as identified in TS 38.300). K_{RRCenc} may be a key derived by the base station for encryption protection of RRC signaling. K_{UPenc} may be a key derived by the base station for encryption protection of UP traffic. Also, those skilled in the art may derive the encryption key in any other possible ways according to actual situation.

In some other implementations, in the HASH protection mechanism, the protected control PDU may be determined by applying a HASH algorithm on the control PDU. An output of the HASH algorithm may be determined as the protected control PDU. The HASH algorithm may be SHA-256 or any other possible HASH algorithms which is applicable.

In some examples, an input of the HASH algorithm may be the control PDU itself. In some other examples, an input of the HASH algorithm may be a combination of the control PDU and an additional random value. The random value for the HASH algorithm may be indicated to the peer entity. The random value may be indicated either in an explicit manner or an implicit manner. For the implicit manner, the random value may be indicated by an index corresponding to the random value.

At step S206, the transmitter may transmit the protected control PDU, e.g., to a receiver in the wireless communication system.

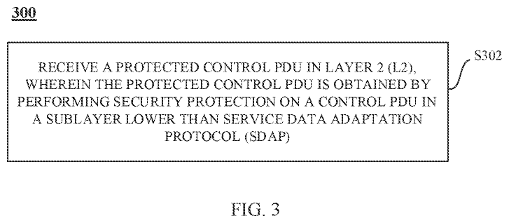

FIG. 3 illustrates a flowchart for an exemplary method of a receiver in accordance with some embodiments. The method 300 illustrated in FIG. 3 may be implemented by the UE 101 or base station 150 described in FIG. 1 as a receiver in the wireless communication system.

At S302, the receiver may receive a protected control PDU in layer 2 (L2), wherein the protected control PDU is obtained by performing security protection on a control PDU in a sublayer lower than service data adaptation protocol (SDAP).

The protected control PDU may be a PDCP control PDU, a RLC control PDU or a MAC control PDU (MAC control element (MAC-CE)).

The protected control PDU may be derived from a corresponding control PDU in a sublayer lower than SDAP according to the security protection as illustrated in connection with FIG. 2 (e.g., the integrity protection, ciphering protection or HASH protection). The security protection may be the same as those described in connection with FIG. 2.

In some embodiment, in the integrity protection mechanism, the protected control PDU may be determined by applying an integrity protection algorithm on the control PDU to be protected. Based on an output of the integrity protection algorithm, a signature (e.g., MAC-I) may be determined, and a combination of the control PDU and the signature may be determined as the protected control PDU. For example, the signature may be assembled with original control PDU to obtain the protected control PDU.

In case that the protected control PDU is obtained based on an integrity protection algorithm, the receiver may further perform integrity verification for the protected control PDU based on the signature. If the signature is faulty or missing, the protected control PDU may be discarded by the receiver.

In some implementations, the integrity protection algorithm may include integrity protection algorithms for 5G system, e.g., 128-NIA1, 128-NIA2, or 128-NIA3. In some other implementations, the integrity protection algorithm may include integrity protection algorithms for LTE system or 3G system, e.g., EIA1, EIA2, EIA3, UIA1, or UIA2. Those skilled in the art may apply any other possible integrity protection algorithm on the control PDU according to actual situation.

Inputs of the integrity protection algorithm for the control PDUs may include: a COUNT parameter: a DIRECTION parameter; a BEARER parameter; and an integrity protection key.

The COUNT parameter and the BEARER parameter may be set based on any possible values to differentiate different control PDUs, or being common to all the control PDUs to be protected.

In some examples, the COUNT parameter of the integrity protection algorithm may be a fixed COUNT value. For example, the COUNT parameter of the integrity protection algorithm may be set to 0 or any other possible values. In some other examples, the COUNT parameter of the integrity protection algorithm may be a sequency number (SN) allocated in a lower layer. For example, for a PDCP control PDU to be protected, the COUNT parameter of the integrity protection algorithm may be determined by a RLC SN. For a RLC control PDU to be protected, the COUNT parameter of the integrity protection algorithm may be determined by a MAC SN. In yet other examples, the COUNT parameter of the integrity protection algorithm may be determined as a random value. In case that the COUNT parameter of the integrity protection algorithm is a random value, the random value may be indicated to a peer entity. The random value may be indicated either in an explicit manner or an implicit manner. For the implicit manner, the random value may be indicated by an index corresponding to the random value.

In some examples, the BEARER parameter of the integrity protection algorithm may be a BEARER ID of a bearer associated with the control PDU. In another example, the BEARER parameter of the integrity protection algorithm may be a fixed value. For example, the BEARER parameter of the integrity protection algorithm may be set to 0 or any other possible values. In some other examples, the BEARER parameter of the integrity protection algorithm may be a control PDU type indication. For example, the BEARER parameter of the integrity protection algorithm may be a value in a field of the control PDU which indicates a type of the control PDU to be protected. In yet some other examples, the BEARER parameter of the integrity protection algorithm may be a value in any other specified field of the control PDU to be protected. For example, the type of the control PDU may be represented by an LCID of a MAC-CE.

The DIRECTION parameter of the integrity protection algorithm may indicate an uplink (UL) direction or a downlink (DL) direction. In some examples, the DIRECTION parameter of the integrity protection algorithm may be set to 0 to indicate the UL direction and 1 to indicate the DL direction. Those skilled in the art may set the DIRECTION parameter of the integrity protection algorithm to any other possible values according to actual situation.

The integrity protection key may include an integrity protection key K_{RRCint} or K_{UPint} (as identified in TS 38.300). K_{RRCint} may be a key derived by the base station for integrity protection of RRC signaling. K_{UPint} may be a key derived by the base station for integrity protection of UP traffic. Also, those skilled in the art may derive the integrity protection key in any other possible ways according to actual situation.

In some other implementations, in the ciphering mechanism, the protected control PDU may be determined by applying a ciphering algorithm on the control PDU to be protected. An output of the ciphering algorithm may be determined as the protected control PDU.

In case that the protected control PDU is obtained based on the ciphering algorithm, the receiver may determine the control PDU by applying corresponding decipher algorithm on the protected control PDU, to obtain plain text of the control PDU.

In some implementations, the ciphering algorithm may include ciphering algorithms for 5G system, e.g., 128-NEA1, 128-NEA2, or 128-NEA3. In some other implementations, the ciphering algorithm may include ciphering algorithms for LTE system or 3G system, e.g., 128-EEA1, 128-EEA2, 128-EEA3, UEA1, or UEA2. Those skilled in the art may apply any other possible ciphering algorithm on the control PDU according to actual situation.

Inputs of the ciphering algorithm may include: a COUNT parameter; a DIRECTION parameter; a BEARER parameter; and an encryption key.

The COUNT parameter and the BEARER parameter may be set based on any possible values to differentiate different control PDUs, or being common to all the control PDUs to be protected.

In some examples, the COUNT parameter of the ciphering algorithm may be a fixed COUNT value. For example, the COUNT parameter of the ciphering algorithm may be set to 0 or any other possible values. In some other examples, the COUNT parameter of the ciphering algorithm may be a sequency number (SN) allocated in a lower layer. For example, for a PDCP control PDU to be protected, the COUNT parameter of the ciphering algorithm may be determined by a RLC SN. For a RLC control PDU to be protected, the COUNT parameter of the ciphering algorithm may be determined by a MAC SN. In yet other examples, the COUNT parameter of the ciphering algorithm may be determined as a random value. In case that the COUNT parameter of the ciphering algorithm is a random value, the random value may be indicated to a peer entity. The random value may be indicated either in an explicit manner or an implicit manner. For the implicit manner, the random value may be indicated by an index corresponding to the random value.

In some examples, the BEARER parameter of the ciphering algorithm may be a BEARER ID of a bearer associated with the control PDU. In another example, the BEARER parameter of the ciphering algorithm may be a fixed value. For example, the BEARER parameter of the ciphering algorithm may be set to 0 or any other possible values. In some other examples, the BEARER parameter of the ciphering algorithm may be a control PDU type indication. For example, the BEARER parameter of the ciphering algorithm may be a value in a field of the control PDU which indicates a type of the control PDU to be protected. In yet some other examples, the BEARER parameter of the ciphering algorithm may be a value in any other specified field of the control PDU to be protected. For example, the type of the control PDU may be represented by an LCID of a MAC-CE.

The DIRECTION parameter of the ciphering algorithm may indicate an uplink (UL) direction or a downlink (DL) direction. In some examples, the DIRECTION parameter of the ciphering algorithm may be set to 0 to indicate the UL direction and 1 to indicate the DL direction. Those skilled in the art may set the DIRECTION parameter of the ciphering algorithm to any other possible values according to actual situation.

The encryption key may include an encryption key K_{RRCenc} or K_{UPenc} (as identified in TS 38.300). K_{RRCenc} may be a key derived by the base station for encryption protection of RRC signaling. K_{UPenc} may be a key derived by the base station for encryption protection of UP traffic. Also, those skilled in the art may derive the encryption key in any other possible ways according to actual situation.

In some other implementations, in the HASH protection mechanism, the protected control PDU may be determined by applying a HASH algorithm on the control PDU. An output of the HASH algorithm may be determined as the protected control PDU. The HASH algorithm may be SHA-256 or any other possible HASH algorithms which is applicable.

In case that the protected control PDU is obtained based on a HASH algorithm, the receiver may determine the control PDU by applying an inverse HASH algorithm on the protected control PDU, in order to obtain plain text of the control PDU.

In some examples, an input of the HASH algorithm may be the control PDU itself. In some other examples, an input of the HASH algorithm may be a combination of the control PDU and an additional random value. The random value for the HASH algorithm may be indicated to the peer entity. The random value may be indicated either in an explicit manner or an implicit manner. For the implicit manner, the random value may be indicated by an index corresponding to the random value.

According to embodiments of the present application, by applying protection algorithm on at least one control PDU in the sublayer lower than SDAP, improved protection is applied to L2 PDUs, and attack to L2 control PDUs may be prevented effectively.

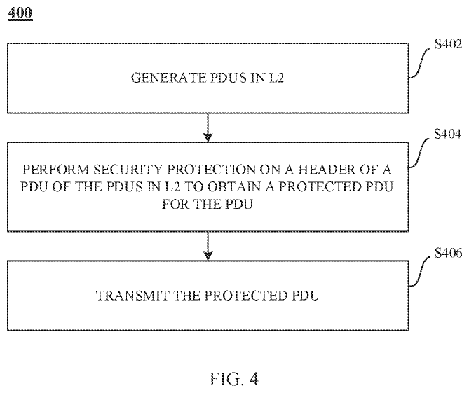

FIG. 4 illustrates a flowchart for an exemplary method of a transmitter in accordance with some embodiments. The method 400 illustrated in FIG. 4 may be implemented by the UE 101 or base station 150 described in FIG. 1 as a transmitter in the wireless communication system.

At step S402, the transmitter may generate PDUs in L2. The PDUs in L2 may include SDAP PDU, PDCP PDU, RLC PDU, MAC PDU, or MAC sub PDU.

At step S404, the transmitter may perform security protection on a header of a PDU of the PDUs in L2 to obtain a protected PDU for the PDU, wherein the PDU in a sublayer lower than packet data convergence protocol (PDCP). For example, the PDU may be a RLC PDU or a MAC PDU (e.g., a MAC sub PDU since a header may be generated in a MAC subPDU level), and the header of the RLC PDU or the MAC PDU may be protected by the security protection.

The security protection for the header of the PDU may include integrity protection or any other security protection mechanism which is applicable according to actual situation.

In some embodiment, in the integrity protection mechanism, the protected PDU may be determined by applying an integrity protection algorithm on at least the header of PDU to be protected. Based on an output of the integrity protection algorithm, a header signature (e.g., MAC-I) for the header of the PDU may be determined, and a combination of the PDU and the header signature may be determined as the protected PDU. For example, the header signature may be assembled with original PDU to obtain the protected PDU.

In some implementations, the integrity protection algorithm may be applied on the header of the PDU only. In some other implementations, the integrity protection algorithm may be applied on the whole PDU. The security protection on the whole PDU may provide a complete protection for the PDU. However, the security protection on only the header of the PDU may minimize the workload for the security protection procedure.

For PDUs such as MAC subPDUs or RLC PDUs, MAC-I may be introduced and carried in MAC subPDUs or RLC PDUs level. In some examples, the MAC-I may be calculated based on the header of the MAC subPDU or the header of the RLC header only. In another examples, the MAC-I may be calculated based on the whole MAC subPDU including the MAC header or the whole RLC including the RLC header only.

In some implementations, if the integrity protection is applied to the whole PDU, i.e., the MAC-I is calculated based on the whole PDU, integrity protection in upper layers will not be needed, since the content of the upper layer PDUs has been integrity protected by the whole PDU in lower layers. For example, if MAC-I is calculated based on whole MAC subPDU, there is no need to apply the integrity protection in PDCP and RLC layer.

For example, a field of MAC-I may be added to a DL MAC PDU as illustrated in FIG. 6.1.2-4 in TS 38.321, the status PDU may be security protected by computing and adding a MAC-I to generate a protected status PDU. Other RLC control PDUs, PDCP control PDUs as illustrated in TS 38.322 or MAC control PDUs as illustrated in TS 38.321 may also be integrity protected in a similar way.

In some implementations, the integrity protection algorithm may include integrity protection algorithms for 5G system, e.g., 128-NIA1, 128-NIA2, or 128-NIA3. In some other implementations, the integrity protection algorithm may include integrity protection algorithms for LTE system or 3G system, e.g., EIA1, EIA2, EIA3, UIA1, or UIA2. Those skilled in the art may apply any other possible integrity protection algorithm on the header of the PDU according to actual situation.

Inputs of the integrity protection algorithm for the header of the PDU may include: a COUNT parameter: a DIRECTION parameter; a BEARER parameter; and an integrity protection key.

The COUNT parameter and the BEARER parameter may be set based on any possible values to differentiate different PDUs, or being common to all the PDUs to be protected.

In some examples, the COUNT parameter of the integrity protection algorithm may be a fixed COUNT value. For example, the COUNT parameter of the integrity protection algorithm may be set to 0 or any other possible values. In some other examples, the COUNT parameter of the integrity protection algorithm may be a sequency number (SN) allocated in a lower layer. In yet other examples, the COUNT parameter of the integrity protection algorithm may be determined as a random value. In case that the COUNT parameter of the integrity protection algorithm is a random value, the random value may be indicated to a peer entity. The random value may be indicated either in an explicit manner or an implicit manner. For the implicit manner, the random value may be indicated by an index corresponding to the random value.

In some examples, the BEARER parameter of the integrity protection algorithm may be a fixed value. For example, the BEARER parameter of the integrity protection algorithm may be set to 0 or any other possible values. In some other examples, the BEARER parameter of the integrity protection algorithm may be a PDU type indication. For example, the BEARER parameter of the integrity protection algorithm may be a value in a field of the PDU which indicates a type of the PDU to be protected. In yet some other examples, the BEARER parameter of the integrity protection algorithm may be a value in any other specified field of the PDU to be protected.

The DIRECTION parameter of the integrity protection algorithm may indicate an uplink (UL) direction or a downlink (DL) direction. In some examples, the DIRECTION parameter of the integrity protection algorithm may be set to 0 to indicate the UL direction and 1 to indicate the DL direction. Those skilled in the art may set the DIRECTION parameter of the integrity protection algorithm to any other possible values according to actual situation.

The integrity protection key may include an integrity protection key K_{RRCint} or K_{UPint} (as identified in TS 38.300). K_{RRCint} may be a key derived by the base station for integrity protection of RRC signaling. K_{UPint} may be a key derived by the base station for integrity protection of UP traffic. Also, those skilled in the art may derive the integrity protection key in any other possible ways according to actual situation.

At step S406, the transmitter may transmit the protected PDU, to a receiver in the wireless communication system.

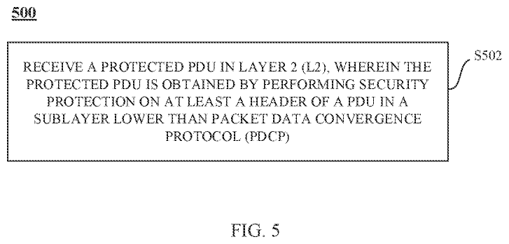

FIG. 5 illustrates a flowchart for an exemplary method of a receiver in accordance with some embodiments. The method 500 illustrated in FIG. 5 may be implemented by the UE 101 or base station 150 described in FIG. 1 as a receiver in the wireless communication system.

At step S502, the receiver may receive a protected PDU in layer 2 (L2), wherein the protected PDU is obtained by performing security protection on at least a header of a PDU in a sublayer lower than packet data convergence protocol (PDCP).

The protected PDU may be a RLC PDU or a MAC PDU, and the header of the RLC PDU or the MAC PDU may be protected by the security protection.

The security protection for the header of the PDU may include integrity protection as described in connection with FIG. 3 or any other security protection mechanism which is applicable according to actual situation.

In some embodiment, in the integrity protection mechanism, the protected PDU may be determined by applying an integrity protection algorithm on at least the header of PDU to be protected. Based on an output of the integrity protection algorithm, a header signature (e.g., MAC-I) for the header of the PDU may be determined, and a combination of the PDU and the header signature may be determined as the protected PDU.

In case that the protected PDU is obtained based on the integrity protection mechanism, the receiver may further perform integrity verification for the protected PDU based on the header signature. If the header signature is faulty or missing, the protected PDU may be discarded by the receiver.

In some implementations, the integrity protection algorithm may be applied on the header of the PDU only. In some other implementations, the integrity protection algorithm may be applied on the whole PDU. The security protection on the whole PDU may provide a complete protection for the PDU. However, the security protection on only the header of the PDU may minimize the workload for the security protection procedure.

For PDUs such as MAC subPDUs or RLC PDUs, a signature of MAC-I may be introduced and carried in MAC subPDUs or RLC PDUs level. In some examples, the MAC-I may be calculated based on the header of the MAC subPDU or the header of the RLC header only. In another examples, the MAC-I may be calculated based on the whole MAC subPDU including the MAC header or the whole RLC including the RLC header only.

In some implementations, if the integrity protection is applied to the whole PDU, i.e., the MAC-I is calculated based on the whole PDU, integrity protection in upper layers will not be needed, since the content of the upper layer PDUs has been integrity protected by the whole PDU in lower layers. For example, if MAC-I is calculated based on whole MAC subPDU, there is no need to apply the integrity protection in PDCP and RLC layer.

In some implementations, the integrity protection algorithm may include integrity protection algorithms for 5G system, e.g., 128-NIA1, 128-NIA2, or 128-NIA3. In some other implementations, the integrity protection algorithm may include integrity protection algorithms for LTE system or 3G system, e.g., EIA1, EIA2, EIA3, UIA1, or UIA2. Those skilled in the art may apply any other possible integrity protection algorithm on the header of the PDU according to actual situation.

Inputs of the integrity protection algorithm for the header of the PDU may include: a COUNT parameter: a DIRECTION parameter: a BEARER parameter: and an integrity protection key.

In some examples, the COUNT parameter of the integrity protection algorithm may be a fixed COUNT value. For example, the COUNT parameter of the integrity protection algorithm may be set to 0 or any other possible values. In some other examples, the COUNT parameter of the integrity protection algorithm may be a sequency number (SN) allocated in a lower layer. In yet other examples, the COUNT parameter of the integrity protection algorithm may be determined as a random value. In case that the COUNT parameter of the integrity protection algorithm is a random value, the random value may be indicated to a peer entity. The random value may be indicated either in an explicit manner or an implicit manner. For the implicit manner, the random value may be indicated by an index corresponding to the random value.

In some examples, the BEARER parameter of the integrity protection algorithm may be a fixed value. For example, the BEARER parameter of the integrity protection algorithm may be set to 0 or any other possible values. In some other examples, the BEARER parameter of the integrity protection algorithm may be a PDU type indication. For example, the BEARER parameter of the integrity protection algorithm may be a value in a field of the PDU which indicates a type of the PDU to be protected. In yet some other examples, the BEARER parameter of the integrity protection algorithm may be a value in any other specified field of the PDU to be protected.

The DIRECTION parameter of the integrity protection algorithm may indicate an uplink (UL) direction or a downlink (DL) direction. In some examples, the DIRECTION parameter of the integrity protection algorithm may be set to 0 to indicate the UL direction and 1 to indicate the DL direction. Those skilled in the art may set the DIRECTION parameter of the integrity protection algorithm to any other possible values according to actual situation.

The integrity protection key may include an integrity protection key K_{RRCint} or K_{UPint} (as identified in TS 38.300). K_{RRCint} may be a key derived by the base station for integrity protection of RRC signaling. K_{UPint} may be a key derived by the base station for integrity protection of UP traffic. Also, those skilled in the art may derive the integrity protection key in any other possible ways according to actual situation.

According to embodiments of the present application, by applying protection algorithm on at least one PDU header in the sublayer lower than PDCP, improved protection is applied to L2 PDUs, and attack to L2 headers may be prevented effectively.

In some embodiments, all the control PDUs in a sublayer lower than SDAP may be protected based on the security protection mechanism illustrated in connection with FIG. 2 and FIG. 3. In some other embodiments, the security protection may not need to be applied to all the control PDUs.

Similarly, in some embodiments, headers of all the PDUs in a sublayer lower than PDCP may be protected based on the security protection mechanism illustrated in connection with FIG. 4 and FIG. 5. In some other embodiments, the security protection may not need to be applied to all the headers of the PDUs.

For example, taking integrity protection mechanism as an example, the signature may not be carried in each packet.

At least one rule may be used to select the packet(s) to be protected, either the control PDU or the header of the PDU.

In some embodiment, the rule may be configured by a network device in the wireless communication system, and the UE in the wireless communication system may follow the NW configured rule to generate protected packets.

In some examples, the rule may include that the packet to be protected may be determined based on a protection frequency in PDU transmission. For example, the protection frequency may be determined as one in every 10 packets. Thus, a protected packet may be generated every 10 packets during the transmission. Those skilled in the art may set the protection frequency to any other values according to actual situation.

In some other examples, the rule may include that one protected packet may be generated in one transmission in Uu interface, assuming that a plurality of packets will be delivered per transport time interval (TTI) in Uu interface.

In yet some other examples, the rule may include that the packet to be protected may be determined based on a protection period for the protected packet transmission. For example, a protected packet may be generated per 10s. Those skilled in the art may set the protection period for the protected packet transmission to any other values according to actual situation.

In some other embodiments, the NW of the wireless communication system may dynamically trigger protected packet transmission.

In some other embodiments, the rule may include that the packet to be protected may be determined in response to a dynamic trigger. For example, the UE in the wireless communication system may receive a trigger indicating security protection should be activated for control PDUs and/or headers of the PDUs in L2, thus the UE may apply security protection as described in connection with FIG. 2 and FIG. 4 on control PDUs and/or headers of PDUs in L2.

In yet some other embodiments, the NW of the wireless communication system may configure to enable the security protection for at least one specified PDU type. For example, the rule may include that the packet to be protected may be determined with the specified PDU type(s). Based on the NW configuration, the transmitter of the wireless communication system may perform security protection as described in connection with FIG. 2 and FIG. 4 on the specified type of control PDU and/or header of PDU in L2.

The at least one rule may be configured by a NW device of the wireless communication system

In case that the security protection is dynamically performed for the L2 PDUs, explicit indication of whether the packet is protected may be included in the packet. Thus, the peer entity may be able to identify whether the received packet is protected. In some examples, the protected packet may include at least one bit indicating that the packet has been protected. When integrity protection is applied to the packets, the protected packet may explicitly indicate that whether a MAC-I is present or not.

In some embodiments, the UE of the wireless communication may detect security risk. The UE may detect an occurrence of a security problem when the connection between the UE and the NW are abnormal. For example, if the UE detects a security problem in the connection between the UE and the NW of the communication system, the UE may report to the NW about an occurrence of the security problem. The UE may also indicate the NW about a packet type to be protected. For another example, if the UE detects a security problem in the connection between the UE and the NW of the communication system, the UE may trigger UE connection reestablishment or trigger master cell group (MCG)/secondary cell group (SCG) failure procedure. More security protection may be applied to the reestablished connection.

FIG. 6 illustrates a communication exchange in connection with security protection in accordance with some embodiments of the present disclosure.

At operation 603, the base station 602 may transmit a security protection activation to the UE 601. The security protection activation may enable security protection in L2 for the following transmission between the UE and the base station.

The security protection activation may be transmitted via an RRC message or any other possible manners for transmitting control information.

Then security protection activation may also include parameter configurations which may be necessary for the security protection. For example, the security protection activation may indicate a frequency of occurrence of a protected packet, type of the protected packet, parameters needed for the security protection algorithm.

At operation 604, the UE may perform transmission with protected packets. The UE may generate protected packets (e.g., protected control PDUs or PDU with protected header). The protected packets may be generated based on the method as described in connection with FIG. 2 and FIG. 4.

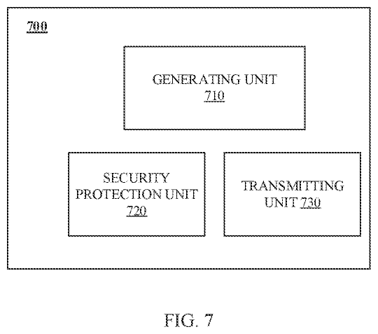

FIG. 7 illustrates an exemplary block diagram of an apparatus of a transmitter in accordance with some embodiments. The apparatus 700 illustrated in FIG. 7 may be used to implement the method 200 as illustrated in combination with FIG. 2 and the method 400 as illustrated in combination with FIG. 4.

As illustrated in FIG. 7, the apparatus 700 includes a generating unit 710, a security protection unit 720 and a transmitting unit 730.

For the security protection for the control PDU, the generating unit 710 may be configured to generate protocol data units (PDU) in layer 2 (L2). The security protection unit 720 may be configured to perform security protection on a control PDU of the PDUs in L2 to obtain a protected control PDU for the control PDU, wherein the control PDU in a sublayer lower than service data adaptation protocol (SDAP). The transmitting unit 730 may be configured to transmit the protected control PDU.

For the security protection for the header of the PDU, the generating unit 710 may be configured to generate protocol data units (PDU) in layer 2 (L2). The security protection unit 720 may be configured to performing security protection on a header of a PDU of the PDUs in L2 to obtain a protected PDU for the PDU, wherein the PDU in a sublayer lower than packet data convergence protocol (PDCP). The transmitting unit 730 may be configured to transmit the protected PDU.

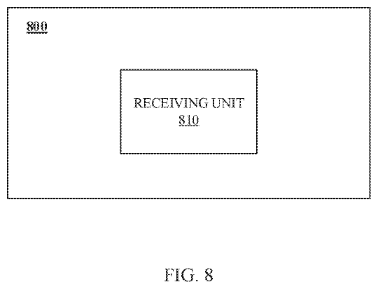

FIG. 8 illustrates an exemplary block diagram of an apparatus of a receiver in accordance with some embodiments. The apparatus 800 illustrated in FIG. 8 may be used to implement the method 300 as illustrated in combination with FIG. 3 and the method 500 as illustrated in combination with FIG. 5.

As illustrated in FIG. 8, the apparatus 800 includes a receiving unit 810.

For the security protection for the control PDU, the receiving unit 810 may be configured to receive a protected control PDU in layer 2 (L2), wherein the protected control PDU is obtained by performing security protection on a control PDU in a sublayer lower than service data adaptation protocol (SDAP).

For the security protection for the header of the PDU, the receiving unit 810 may be configured to receive a protected PDU in layer 2 (L2), wherein the protected PDU is obtained by performing security protection on at least a header of a PDU in a sublayer lower than packet data convergence protocol (PDCP).

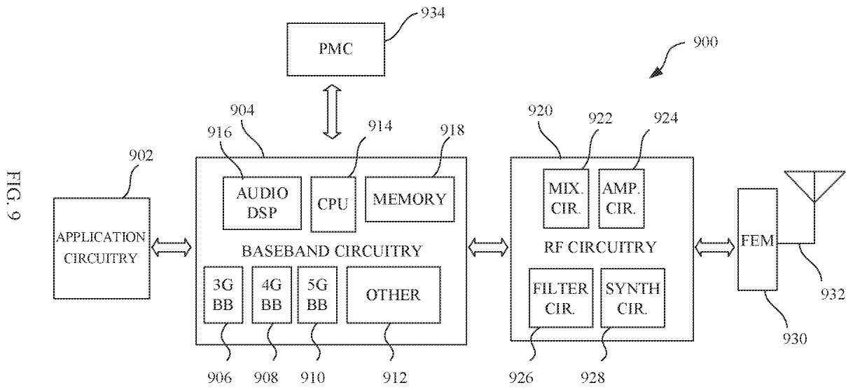

FIG. 9 illustrates example components of a device 900 in accordance with some embodiments. In some embodiments, the device 900 may include application circuitry 902, baseband circuitry 904, Radio Frequency (RF) circuitry (shown as RF circuitry 920), front-end module (FEM) circuitry (shown as FEM circuitry 930), one or more antennas 932, and power management circuitry (PMC) (shown as PMC 934) coupled together at least as shown. The components of the illustrated device 900 may be included in a UE or a RAN node. In some embodiments, the device 900 may include fewer elements (e.g., a RAN node may not utilize application circuitry 902, and instead include a processor/controller to process IP data received from an EPC). In some embodiments, the device 900 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 902 may include one or more application processors. For example, the application circuitry 902 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 900. In some embodiments, processors of application circuitry 902 may process IP data packets received from an EPC.

The baseband circuitry 904 may include circuitry such as, but not limited to, one or more single-core or multi-core processors. The baseband circuitry 904 may include one or more baseband processors or control logic to process baseband signals received from a receive signal path of the RF circuitry 920 and to generate baseband signals for a transmit signal path of the RF circuitry 920. The baseband circuitry 904 may interface with the application circuitry 902 for generation and processing of the baseband signals and for controlling operations of the RF circuitry 920. For example, in some embodiments, the baseband circuitry 904 may include a third generation (3G) baseband processor (3G baseband processor 906), a fourth generation (4G) baseband processor (4G baseband processor 908), a fifth generation (5G) baseband processor (5G baseband processor 910), or other baseband processor(s) 912 for other existing generations, generations in development or to be developed in the future (e.g., second generation (2G), sixth generation (6G), etc.). The baseband circuitry 904 (e.g., one or more of baseband processors) may handle various radio control functions that enable communication with one or more radio networks via the RF circuitry 920. In other embodiments, some or all of the functionality of the illustrated baseband processors may be included in modules stored in the memory 918 and executed via a Central Processing ETnit (CPET 914). The radio control functions may include, but are not limited to, signal modulation/demodulation, encoding/decoding, radio frequency shifting, etc. In some embodiments, modulation/demodulation circuitry of the baseband circuitry 904 may include Fast-Fourier Transform (FFT), precoding, or constellation mapping/demapping functionality. In some embodiments, encoding/decoding circuitry of the baseband circuitry 904 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 904 may include a digital signal processor (DSP), such as one or more audio DSP(s) 916. The one or more audio DSP(s) 916 may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 904 and the application circuitry 902 may be implemented together such as, for example, on a system on a chip (SOC).

In some embodiments, the baseband circuitry 904 may provide for communication compatible with one or more radio technologies. For example, in some embodiments, the baseband circuitry 904 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 904 is configured to support radio communications of more than one wireless protocol may be referred to as multi-mode baseband circuitry.

The RF circuitry 920 may enable communication with wireless networks using modulated electromagnetic radiation through a non-solid medium. In various embodiments, the RF circuitry 920 may include switches, filters, amplifiers, etc. to facilitate the communication with the wireless network. The RF circuitry 920 may include a receive signal path which may include circuitry to down-convert RF signals received from the FEM circuitry 930 and provide baseband signals to the baseband circuitry 904. The RF circuitry 920 may also include a transmit signal path which may include circuitry to up-convert baseband signals provided by the baseband circuitry 904 and provide RF output signals to the FEM circuitry 930 for transmission.

In some embodiments, the receive signal path of the RF circuitry 920 may include mixer circuitry 922, amplifier circuitry 924 and filter circuitry 926. In some embodiments, the transmit signal path of the RF circuitry 920 may include filter circuitry 926 and mixer circuitry 922. The RF circuitry 920 may also include synthesizer circuitry 928 for synthesizing a frequency for use by the mixer circuitry 922 of the receive signal path and the transmit signal path. In some embodiments, the mixer circuitry 922 of the receive signal path may be configured to down-convert RF signals received from the FEM circuitry 930 based on the synthesized frequency provided by synthesizer circuitry 928. The amplifier circuitry 924 may be configured to amplify the down-converted signals and the filter circuitry 926 may be a low-pass filter (LPF) or band-pass filter (BPF) configured to remove unwanted signals from the down-converted signals to generate output baseband signals. Output baseband signals may be provided to the baseband circuitry 904 for further processing. In some embodiments, the output baseband signals may be zero-frequency baseband signals, although this is not a requirement. In some embodiments, the mixer circuitry 922 of the receive signal path may comprise passive mixers, although the scope of the embodiments is not limited in this respect.

In some embodiments, the mixer circuitry 922 of the transmit signal path may be configured to up-convert input baseband signals based on the synthesized frequency provided by the synthesizer circuitry 928 to generate RF output signals for the FEM circuitry 930. The baseband signals may be provided by the baseband circuitry 904 and may be filtered by the filter circuitry 926.

In some embodiments, the mixer circuitry 922 of the receive signal path and the mixer circuitry 922 of the transmit signal path may include two or more mixers and may be arranged for quadrature downconversion and upconversion, respectively. In some embodiments, the mixer circuitry 922 of the receive signal path and the mixer circuitry 922 of the transmit signal path may include two or more mixers and may be arranged for image rejection (e.g., Hartley image rejection). In some embodiments, the mixer circuitry 922 of the receive signal path and the mixer circuitry 922 may be arranged for direct downconversion and direct upconversion, respectively. In some embodiments, the mixer circuitry 922 of the receive signal path and the mixer circuitry 922 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 920 may include analog-to-digital converter (ADC) and digital-to-analog converter (DAC) circuitry and the baseband circuitry 904 may include a digital baseband interface to communicate with the RF circuitry 920.

In some dual-mode embodiments, a separate radio IC circuitry may be provided for processing signals for each spectrum, although the scope of the embodiments is not limited in this respect.

In some embodiments, the synthesizer circuitry 928 may be a fractional −N synthesizer or a fractional N/N+1 synthesizer, although the scope of the embodiments is not limited in this respect as other types of frequency synthesizers may be suitable. For example, synthesizer circuitry 928 may be a delta-sigma synthesizer, a frequency multiplier, or a synthesizer comprising a phase-locked loop with a frequency divider.

The synthesizer circuitry 928 may be configured to synthesize an output frequency for use by the mixer circuitry 922 of the RF circuitry 920 based on a frequency input and a divider control input. In some embodiments, the synthesizer circuitry 928 may be a fractional N/N+1 synthesizer.

In some embodiments, frequency input may be provided by a voltage controlled oscillator (VCO), although that is not a requirement. Divider control input may be provided by either the baseband circuitry 904 or the application circuitry 902 (such as an applications processor) depending on the desired output frequency. In some embodiments, a divider control input (e.g., N) may be determined from a look-up table based on a channel indicated by the application circuitry 902.

Synthesizer circuitry 928 of the RF circuitry 920 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 928 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 920 may include an IQ/polar converter.

The FEM circuitry 930 may include a receive signal path which may include circuitry configured to operate on RF signals received from one or more antennas 932, amplify the received signals and provide the amplified versions of the received signals to the RF circuitry 920 for further processing. The FEM circuitry 930 may also include a transmit signal path which may include circuitry configured to amplify signals for transmission provided by the RF circuitry 920 for transmission by one or more of the one or more antennas 932. In various embodiments, the amplification through the transmit or receive signal paths may be done solely in the RF circuitry 920, solely in the FEM circuitry 930, or in both the RF circuitry 920 and the FEM circuitry 930.

In some embodiments, the FEM circuitry 930 may include a TX/RX switch to switch between transmit mode and receive mode operation. The FEM circuitry 930 may include a receive signal path and a transmit signal path. The receive signal path of the FEM circuitry 930 may include an LNA to amplify received RF signals and provide the amplified received RF signals as an output (e.g., to the RF circuitry 920). The transmit signal path of the FEM circuitry 930 may include a power amplifier (PA) to amplify input RF signals (e.g., provided by the RF circuitry 920), and one or more filters to generate RF signals for subsequent transmission (e.g., by one or more of the one or more antennas 932).

In some embodiments, the PMC 934 may manage power provided to the baseband circuitry 904. In particular, the PMC 934 may control power-source selection, voltage scaling, battery charging, or DC-to-DC conversion. The PMC 934 may often be included when the device 900 is capable of being powered by a battery, for example, when the device 900 is included in an EGE. The PMC 934 may increase the power conversion efficiency while providing desirable implementation size and heat dissipation characteristics.

FIG. 9 shows the PMC 934 coupled only with the baseband circuitry 904.

However, in other embodiments, the PMC 934 may be additionally or alternatively coupled with, and perform similar power management operations for, other components such as, but not limited to, the application circuitry 902, the RF circuitry 920, or the FEM circuitry 930.

In some embodiments, the PMC 934 may control, or otherwise be part of, various power saving mechanisms of the device 900. For example, if the device 900 is in an RRC Connected state, where it is still connected to the RAN node as it expects to receive traffic shortly, then it may enter a state known as Discontinuous Reception Mode (DRX) after a period of inactivity. During this state, the device 900 may power down for brief intervals of time and thus save power.

If there is no data traffic activity for an extended period of time, then the device 900 may transition off to an RRC Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 902 and processors of the baseband circuitry 904 may be used to execute elements of one or more instances of a protocol stack. For example, processors of the baseband circuitry 904, alone or in combination, may be used to execute Layer 3, Layer 2, or Layer 1 functionality, while processors of the application circuitry 902 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

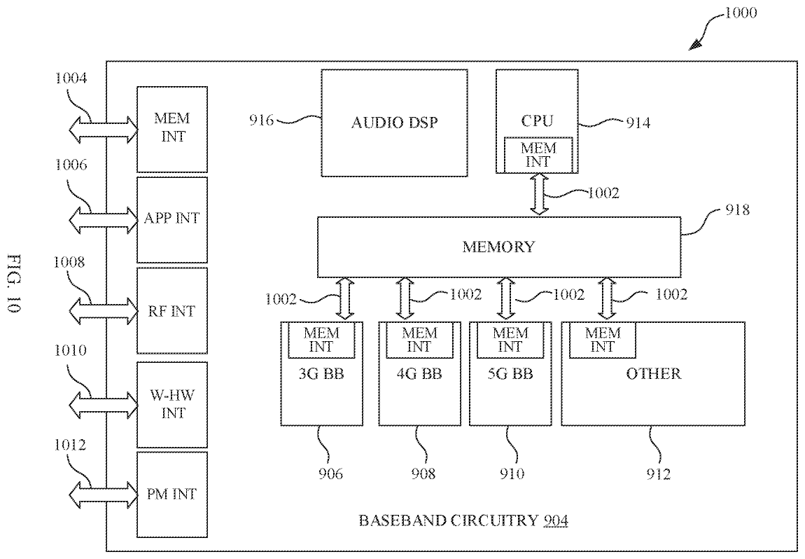

FIG. 10 illustrates example interfaces 1000 of baseband circuitry in accordance with some embodiments. As discussed above, the baseband circuitry 904 of FIG. 9 may comprise 3G baseband processor 906, 4G baseband processor 908, 5G baseband processor 910, other baseband processor(s) 912, CPU 914, and a memory 918 utilized by said processors. As illustrated, each of the processors may include a respective memory interface 1002 to send/receive data to/from the memory 918.

The baseband circuitry 904 may further include one or more interfaces to communicatively couple to other circuitries/devices, such as a memory interface 1004 (e.g., an interface to send/receive data to/from memory external to the baseband circuitry 904), an application circuitry interface 1006 (e.g., an interface to send/receive data to/from the application circuitry 902 of FIG. 9), an RF circuitry interface 1008 (e.g., an interface to send/receive data to/from RF circuitry 920 of FIG. 9), a wireless hardware connectivity interface 1010 (e.g., an interface to send/receive data to/from Near Field Communication (NFC) components, Bluetooth® components (e.g., Bluetooth® Low Energy), Wi-Fi® components, and other communication components), and a power management interface 1012 (e.g., an interface to send/receive power or control signals to/from the PMC 934.

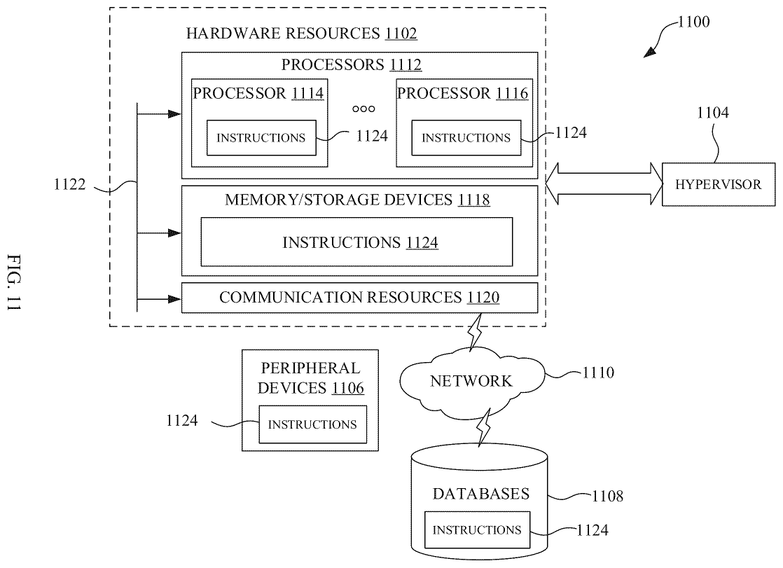

FIG. 11 is a block diagram illustrating components 1100, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1102 including one or more processors 1112 (or processor cores), one or more memory/storage devices 1118, and one or more communication resources 1120, each of which may be communicatively coupled via a bus 1122. For embodiments where node virtualization (e.g., NFV) is utilized, a hypervisor 1104 may be executed to provide an execution environment for one or more network slices/sub-slices to utilize the hardware resources 1102.

The processors 1112 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1114 and a processor 1116.

The memory/storage devices 1118 may include main memory, disk storage, or any suitable combination thereof. The memory/storage devices 1118 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1120 may include interconnection or network interface components or other suitable devices to communicate with one or more peripheral devices 1106 or one or more databases 1108 via a network 1110. For example, the communication resources 1120 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1124 may comprise software, a program, an application, an applet, an app, or other executable code for causing at least any of the processors 1112 to perform any one or more of the methodologies discussed herein. The instructions 1124 may reside, completely or partially, within at least one of the processors 1112 (e.g., within the processor's cache memory), the memory/storage devices 1118, or any suitable combination thereof. Furthermore, any portion of the instructions 1124 may be transferred to the hardware resources 1102 from any combination of the peripheral devices 1106 or the databases 1108. Accordingly, the memory of the processors 1112, the memory/storage devices 1118, the peripheral devices 1106, and the databases 1108 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

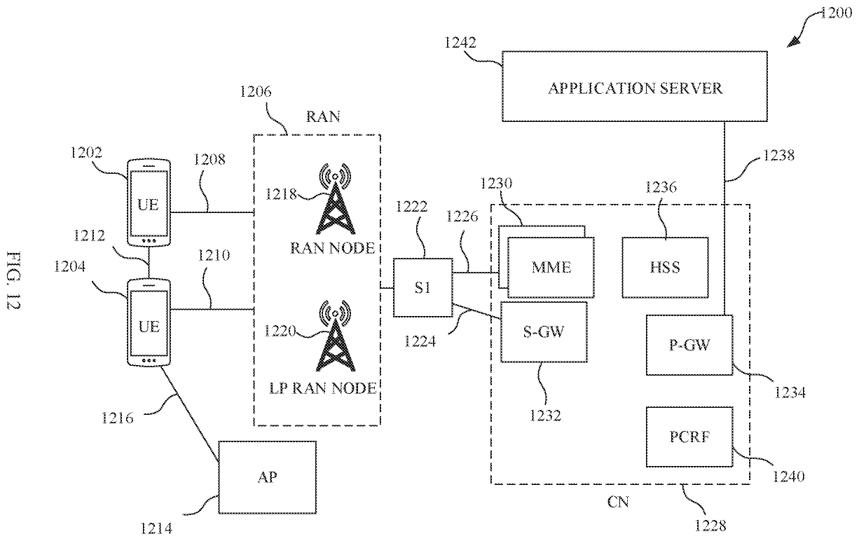

FIG. 12 illustrates an architecture of a system 1200 of a network in accordance with some embodiments. The system 1200 includes one or more user equipment (UE), shown in this example as a UE 1202 and a UE 1204. The UE 1202 and the UE 1204 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UE 1202 and the UE 1204 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UE 1202 and the UE 1204 may be configured to connect, e.g., communicatively couple, with a radio access network (RAN), shown as RAN 1206. The RAN 1206 may be, for example, an Evolved ETniversal Mobile Telecommunications System (ETMTS) Terrestrial Radio Access Network (E-UTRAN), a NextGen RAN (NG RAN), or some other type of RAN. The UE 1202 and the UE 1204 utilize connection 1208 and connection 1210, respectively, each of which comprises a physical communications interface or layer (discussed in further detail below): in this example, the connection 1208 and the connection 1210 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 1202 and the UE 1204 may further directly exchange communication data via a ProSe interface 1212. The ProSe interface 1212 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1204 is shown to be configured to access an access point (AP), shown as AP 1214, via connection 1216. The connection 1216 can comprise a local wireless connection, such as a connection consistent with any IEEE 802.11 protocol, wherein the AP 1214 would comprise a wireless fidelity (WiFi®) router. In this example, the AP 1214 may be connected to the Internet without connecting to the core network of the wireless system (described in further detail below).

The RAN 1206 can include one or more access nodes that enable the connection 1208 and the connection 1210. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 1206 may include one or more RAN nodes for providing macrocells, e.g., macro RAN node 1218, and one or more RAN nodes for providing femtocells or picocells (e.g., cells having smaller coverage areas, smaller user capacity, or higher bandwidth compared to macrocells), e.g., a low power (LP) RAN node such as LP RAN node 1220.

Any of the macro RAN node 1218 and the LP RAN node 1220 can terminate the air interface protocol and can be the first point of contact for the UE 1202 and the UE 1204. In some embodiments, any of the macro RAN node 1218 and the LP RAN node 1220 can fulfill various logical functions for the RAN 1206 including, but not limited to, radio network controller (RNC) functions such as radio bearer management, uplink and downlink dynamic radio resource management and data packet scheduling, and mobility management.

In accordance with some embodiments, the EGE 1202 and the EGE 1204 can be configured to communicate using Orthogonal Frequency-Division Multiplexing (OFDM) communication signals with each other or with any of the macro RAN node 1218 and the LP RAN node 1220 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal sub carriers.

In some embodiments, a downlink resource grid can be used for downlink transmissions from any of the macro RAN node 1218 and the LP RAN node 1220 to the UE 1202 and the UE 1204, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements: in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1202 and the UE 1204. The physical downlink control channel (PDCCH) may carry information about the transport format and resource allocations related to the PDSCH channel, among other things. It may also inform the UE 1202 and the UE 1204 about the transport format, resource allocation, and H-ARQ (Hybrid Automatic Repeat Request) information related to the uplink shared channel. Typically, downlink scheduling (assigning control and shared channel resource blocks to the UE 1204 within a cell) may be performed at any of the macro RAN node 1218 and the LP RAN node 1220 based on channel quality information fed back from any of the UE 1202 and UE 1204. The downlink resource assignment information may be sent on the PDCCH used for (e.g., assigned to) each of the UE 1202 and the UE 1204.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 1206 is communicatively coupled to a core network (CN), shown as CN 1228—via an S1 interface 1222. In embodiments, the CN 1228 may be an evolved packet core (EPC) network, a NextGen Packet Core (NPC) network, or some other type of CN. In this embodiment the S1 interface 1222 is split into two parts: the S1-U interface 1224, which carries traffic data between the macro RAN node 1218 and the LP RAN node 1220 and a serving gateway (S-GW), shown as S-GW 1232, and an S1-mobility management entity (MME) interface, shown as S1-MME interface 1226, which is a signaling interface between the macro RAN node 1218 and LP RAN node 1220 and the MME(s) 1230.

In this embodiment, the CN 1228 comprises the MME(s) 1230, the S-GW 1232, a Packet Data Network (PDN) Gateway (P-GW) (shown as P-GW 1234), and a home subscriber server (HSS) (shown as HSS 1236). The MME(s) 1230 may be similar in function to the control plane of legacy Serving General Packet Radio Service (GPRS) Support Nodes (SGSN). The MME(s) 1230 may manage mobility aspects in access such as gateway selection and tracking area list management. The HSS 1236 may comprise a database for network users, including subscription-related information to support the network entities' handling of communication sessions. The CN 1228 may comprise one or several HSS 1236, depending on the number of mobile subscribers, on the capacity of the equipment, on the organization of the network, etc. For example, the HSS 1236 can provide support for routing/roaming, authentication, authorization, naming/addressing resolution, location dependencies, etc.

The S-GW 1232 may terminate the S1 interface 322 towards the RAN 1206, and routes data packets between the RAN 1206 and the CN 1228. In addition, the S-GW 1232 may be a local mobility anchor point for inter-RAN node handovers and also may provide an anchor for inter-3 GPP mobility. Other responsibilities may include lawful intercept, charging, and some policy enforcement.

The P-GW 1234 may terminate an SGi interface toward a PDN. The P-GW 1234 may route data packets between the CN 1228 (e.g., an EPC network) and external networks such as a network including the application server 1242 (alternatively referred to as application function (AF)) via an Internet Protocol (IP) interface (shown as IP communications interface 1238). Generally, an application server 1242 may be an element offering applications that use IP bearer resources with the core network (e.g., ETMTS Packet Services (PS) domain, LTE PS data services, etc.). In this embodiment, the P-GW 1234 is shown to be communicatively coupled to an application server 1242 via an IP communications interface 1238. The application server 1242 can also be configured to support one or more communication services (e.g., Voice-over-Internet Protocol (VOIP) sessions, PTT sessions, group communication sessions, social networking services, etc.) for the UE 1202 and the UE 1204 via the CN 1228.

The P-GW 1234 may further be a node for policy enforcement and charging data collection. A Policy and Charging Enforcement Function (PCRF) (shown as PCRF 1240) is the policy and charging control element of the CN 1228. In a non-roaming scenario, there may be a single PCRF in the Home Public Land Mobile Network (HPLMN) associated with a ETE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1240 may be communicatively coupled to the application server 1242 via the P-GW 1234. The application server 1242 may signal the PCRF 1240 to indicate a new service flow and select the appropriate Quality of Service (QOS) and charging parameters. The PCRF 1240 may provision this rule into a Policy and Charging Enforcement Function (PCEF) (not shown) with the appropriate traffic flow template (TFT) and QoS class of identifier (QCI), which commences the QoS and charging as specified by the application server 1242.

### ADDITIONAL EXAMPLES

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.
Example 1 is a method of a transmitter in a wireless communication system, the method comprising: generating protocol data units (PDU) in layer 2 (L2): performing security protection on a control PDU of the PDUs in L2 to obtain a protected control PDU for the control PDU, wherein the control PDU in a sublayer lower than service data adaptation protocol (SDAP); and transmitting the protected control PDU.
Example 2 is the method of Example 1, wherein the protected control PDU is obtained by the steps of: applying an integrity protection algorithm on the control PDU; determining a signature for the control PDU: and determining a combination of the control PDU and the signature as the protected control PDU.
Example 3 is the method of Example 2, wherein inputs of the integrity protection algorithm include: a COUNT parameter: a DIRECTION parameter: a BEARER parameter; and an integrity protection key.
Example 4 is the method of Example 1, wherein the protected control PDU is obtained by the steps of: applying a ciphering algorithm on the control PDU: determining an output of the ciphering algorithm as the protected control PDU.
Example 5 is the method of Example 4, wherein inputs of the ciphering algorithm include: a COUNT parameter: a DIRECTION parameter: a BEARER parameter; and an encryption key.
Example 6 is the method of Example 3 or 5, wherein the COUNT parameter is one of the following items: a fixed COUNT value: a sequence number (SN) allocated in a lower layer: or a random value.
Example 7 is the method of Example 3 or 5, wherein the BEARER parameter is one of the following items: a fixed BEARER value; a control PDU type indication; a value in a specified field of the control PDU.
Example 8 is the method of Example 1, wherein the protected control PDU is obtained by the steps of: applying a HASH algorithm on the control PDU: determining the protected control PDU based on an output of the HASH algorithm.
Example 9 is the method of Example 8, wherein an input of the HASH algorithm is the control PDU and an additional random value.
Example 10 is the method of any one of Examples 1-9, wherein the control PDU is determined based on at least one rules as follows: the control PDU to be protected being determined based on a protection frequency in PDU transmission: one protected control PDU being determined in one transmission in Uu interface: the control PDU to be protected being determined based on a protection period: the control PDU to be protected being determined in response to a dynamic trigger: or the control PDU to be protected being determined with specified PDU types.
Example 11 is the method of Example 10, wherein the at least one rules is configured by a network device of the wireless communication system.
Example 12 is the method of Example 11 or 12, wherein the protected control PDU includes at least one bit indicating that the control PDU has been protected.
Example 13 is the method of any one of Examples 1-12, wherein a user equipment (UE) of the wireless communication system reports to a network device of the wireless communication system about an occurrence of a security problem.
Example 14 is the method of Example 13, the UE transmit recommendation information indicating a type of the control PDU to be protected.
Example 15 is the method of Example 13, the UE trigger UE connection reestablishment or master cell group (MCG)/secondary cell group (SCG) failure procedure.
Example 16 is a method of a receiver in a wireless communication system, the method comprising: receiving a protected control PDU in layer 2 (L2), wherein the protected control PDU is obtained by performing security protection on a control PDU in a sublayer lower than service data adaptation protocol (SDAP).
Example 17 is the method of Example 16, wherein the protected control PDU is obtained by the steps of: applying an integrity protection algorithm on the control PDU; determining a signature for the control PDU; and determining a combination of the control PDU and the signature as the protected control PDU.
Example 18 is the method of Example 17, wherein inputs of the integrity protection algorithm include: a COUNT parameter: a DIRECTION parameter; a BEARER parameter; and an integrity protection key.
Example 19 is the method of Example 16, wherein the protected control PDU is obtained by the steps of: applying a ciphering algorithm on the control PDU: determining an output of the ciphering algorithm as the protected control PDU.
Example 20 is the method of Example 19, wherein inputs of the ciphering algorithm include: a COUNT parameter: a DIRECTION parameter: a BEARER parameter; and an encryption key.
Example 21 is the method of Example 18 or 20, wherein the COUNT parameter is one of the following items: a fixed COUNT value; a sequence number (SN) allocated in a lower layer: or a random value.
Example 22 is the method of Example 18 or 20, wherein the BEARER parameter is one of the following items: a fixed BEARER value; a control PDU type indication: a value in a specified field of the control PDU.
Example 23 is the method of Example 16, wherein the protected control PDU is obtained by the steps of: applying a HASH algorithm on the control PDU: determining the protected control PDU based on an output of the HASH algorithm.
Example 24 is the method of Example 23, wherein an input of the HASH algorithm is the control PDU and an additional random value.
Example 25 is the method of Example 17, further comprising:

performing integrity verification for the protected control PDU based on the signature.
Example 26 is the method of Example 19, further comprising: determining the control PDU by applying a corresponding deciphering algorithm on the protected control PDU.
Example 27 is the method of claim 23, further comprising: determining the control PDU by applying an inverse HASH algorithm on the protected control PDU.
Example 28 is a method of a transmitter in a wireless communication system, the method comprising: generating protocol data units (PDU) in layer 2 (L2): performing security protection on a header of a PDU of the PDUs in L2 to obtain a protected PDU for the PDU, wherein the PDU in a sublayer lower than packet data convergence protocol (PDCP); and transmitting the protected PDU.
Example 29 is the method of Example 28, wherein the protected PDU is obtained by the steps of: applying an integrity protection algorithm on at least the header of the PDU; determining a header signature for the header of the PDU: and determining a combination of the PDU and the header signature as the protected PDU.
Example 30 is the method of Example 29, wherein applying integrity protection algorithm on at least the header of the PDU includes applying integrity protection algorithm on the header only or on the whole PDU.
Example 31 is the method of any one of Examples 28-30, wherein the PDU is Radio Link Control (RLC) PDU or Media Access Control (MAC) subPDU.
Example 32 is the method of any one of Examples 28-31, wherein the PDU to be protected in L2 is determined based on at least one rules as follows: the PDU to be protected being determined based on a protection frequency in PDU transmission: one protected PDU being determined in one transmission in Uu interface: the PDU to be protected being determined based on a protection period: the PDU to be protected being determined in response to a dynamic trigger: or the PDU to be protected being determined with specified PDU types.
Example 33 is the method of Example 32, wherein the at least one rules is configured by a network device of the wireless communication system.
Example 34 is the method of Example 32 or 33, wherein the protected PDU includes at least one bit indicating that the PDU has been protected.
Example 35 is the method of any one of Examples 28-34, wherein a user equipment (UE) of the wireless communication system reports to a network device of the wireless communication system about an occurrence of a security problem.
Example 36 is the method of Example 35, the UE transmit recommendation information indicating a type of the PDU to be protected.
Example 37 is the method of Example 35, the UE trigger UE connection reestablishment or master cell group (MCG)/secondary cell group (SCG) failure procedure.
Example 38 is a method of a receiver in a wireless communication system, the method comprising: receiving a protected PDU in layer 2 (L2), wherein the protected PDU is obtained by performing security protection on at least a header of a PDU in a sublayer lower than packet data convergence protocol (PDCP).
Example 39 is the method of Example 38, wherein the protected PDU is obtained by the steps of: applying an integrity protection algorithm on at least the header of the PDU; determining a header signature for the header of the PDU: and determining a combination of the PDU and the header signature as the protected PDU.
Example 40 is the method of Example 39, wherein applying integrity protection algorithm on at least the header of the PDU includes applying integrity protection algorithm on the header only or on the whole PDU.
Example 41 is the method of Example 40, further comprising: performing integrity verification for the protected PDU based on the header signature.
Example 42 is an apparatus for a transmitter, the apparatus comprising: one or more processors configured to perform steps of the method according to any of Examples 1-15, and 28-37.
Example 43 is an apparatus for a receiver, the apparatus comprising: one or more processors configured to perform steps of the method according to any one of Examples 16-27, and 38-41.
Example 44 is a computer readable medium having computer programs stored thereon which, when executed by one or more processors of an apparatus, cause the apparatus to perform steps of the method according to any of Examples 1-41.
Example 45 is a computer program product comprising computer programs which, when executed by one or more processors of an apparatus, cause the apparatus to perform steps of the method according to any of Examples 1-41.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-45. (canceled)

46. A method of a transmitter in a wireless communication system, the method comprising:
generating protocol data units (PDUs) in layer 2 (L2);
performing security protection on a control PDU of the PDUs in L2 to obtain a protected control PDU for the control PDU, wherein the control PDU is in a sublayer lower than a service data adaptation protocol (SDAP) layer; and
transmitting the protected control PDU.

47. The method of claim 46, wherein the protected control PDU is obtained by:
applying an integrity protection algorithm on the control PDU;
determining a signature for the control PDU; and
determining a combination of the control PDU and the signature as the protected control PDU.

48. The method of claim 47, wherein inputs of the integrity protection algorithm include:
a COUNT parameter;
a DIRECTION parameter;
a BEARER parameter; and
an integrity protection key.

49. The method of claim 47, wherein the protected control PDU is obtained by:
applying a ciphering algorithm on the control PDU; and
determining an output of the ciphering algorithm as the protected control PDU.

50. The method of claim 49, wherein inputs of the ciphering algorithm include:
a COUNT parameter;
a DIRECTION parameter;
a BEARER parameter; and
an encryption key.

51. The method of claim 48, wherein the COUNT parameter is a:
a fixed COUNT value;
a sequence number (SN) allocated in a lower layer; or
a random value.

52. The method of claim 48, wherein the BEARER parameter is:
a fixed BEARER value;
a control PDU type indication; or
a value in a field of the control PDU.

53. The method of claim 46, wherein the protected control PDU is obtained by:
applying a HASH algorithm on the control PDU; and
determining the protected control PDU based on an output of the HASH algorithm.

54. The method of claim 53, wherein an input of the HASH algorithm is the control PDU and an additional random value.

55. The method of claim 46, wherein the control PDU is determined based on a rule that is associated with:
a protection frequency in a PDU transmission;
one protected control PDU being determined in one transmission in Uu interface;
a protection period;
a dynamic trigger; or
a specified PDU type.

56. The method of claim 55, wherein the rule is configured by a network device of the wireless communication system.

57. The method of claim 46, wherein the protected control PDU includes at least one bit indicating that the control PDU has been protected.

58. The method of claim 46, further comprising:
reporting, to a network device of the wireless communication system, an occurrence of a security problem.

59. The method of claim 58, further comprising:
transmitting recommendation information indicating a type of the control PDU to be protected.

60. The method of claim 58, further comprising:
triggering a UE connection reestablishment or master cell group (MCG)/secondary cell group (SCG) failure procedure.

61. One or more non-transitory, computer-readable media having instructions that, when executed by one or more processors, cause a device to:
receive a protected control PDU in layer 2 (L2), wherein the protected control PDU is obtained by performing security protection on a control PDU in a sublayer lower than service data adaptation protocol (SDAP); and
process the protected control PDU.

62. The one or more non-transitory, computer-readable media of claim 61, wherein the protected control PDU is obtained by:
applying an integrity protection algorithm on the control PDU;
determining a signature for the control PDU; and
determining a combination of the control PDU and the signature as the protected control PDU.

63. The one or more non-transitory, computer-readable media of claim 62, wherein inputs of the integrity protection algorithm include:
a COUNT parameter;
a DIRECTION parameter;
a BEARER parameter; and
an integrity protection key.

64. The one or more non-transitory, computer-readable media of claim 61, wherein the protected control PDU is obtained by:
applying a ciphering algorithm on the control PDU; and
determining an output of the ciphering algorithm as the protected control PDU.

65. The one or more non-transitory, computer-readable media of claim 64, wherein inputs of the ciphering algorithm include:
a COUNT parameter;
a DIRECTION parameter;
a BEARER parameter; and
an encryption key.
